(19) United States
(12) Patent Application Publication
(10) Pub. No.: US 2025/0038705 A1
(43) Pub. Date: Jan. 30, 2025

(54) METHODS AND SYSTEMS TO MONITOR PHOTOVOLTAIC SYSTEMS

(71) Applicant: SHOALS TECHNOLOGIES GROUP, LLC, Portland, TN (US)

(72) Inventors: Heath Martin, Portland, TN (US); Philip Odom, Portland, TN (US); John White, Portland, TN (US); John Hass, Portland, TN (US); David Ewing, Portland, TN (US); Donnie Pitts, Portland, TN (US); Jason Whitaker, Portland, TN (US); Dean Solon, Portland, TN (US)

(21) Appl. No.: 18/786,074

(22) Filed: Jul. 26, 2024

Related U.S. Application Data
(60) Provisional application No. 63/516,459, filed on Jul. 28, 2023.

(51) Int. Cl. H02S 50/15; H02S 40/30

(52) U.S. Cl. CPC H02S 50/15; H02S 40/30

(57) ABSTRACT

A method may include generating current and voltage (I-V) data of a photovoltaic (PV) panel at a plurality of predetermined time intervals during operation of the PV panel. The method may also include generating environmental data of a site of the PV panel at the plurality of predetermined time intervals. In addition, the method may include generating I-V characteristic data based on the I-V data and the environmental data. The I-V characteristic data may be representative of actual operating performance of the PV panel over a predetermined period of time corresponding to a duration of the predetermined time intervals.

### CROSS-REFERENCE TO RELATED APPLICATION

This patent application claims the benefit of and priority to U.S. Provisional App. No. 63/516,459 filed Jul. 28, 2023, titled “METHODS AND SYSTEMS TO MONITOR PHOTOVOLTAIC SYSTEMS,” which is incorporated in the present disclosure by reference in its entirety.

### FIELD

The embodiments discussed in the present disclosure are related to methods and systems to monitor photovoltaic (PV) systems.

### BACKGROUND

Unless otherwise indicated in the present disclosure, the materials described in the present disclosure are not prior art to the claims in the present application and are not admitted to be prior art by inclusion in this section.

PV systems may include strings of PV panels that generate power signals based on collected solar radiation. The strings of PV panels may generate the power signals in accordance with various environmental conditions and bin classes of the PV panels. Some PV systems may monitor the PV systems by monitoring the strings of PV panels. These PV systems may use current of the power signals from the strings of PV panels (e.g., at a combiner) to monitor the strings of PV panels. However, these PV systems may only monitor at the level of the strings of PV panels and not at the level of individual PV panels.

Some PV systems may monitor individual PV panels by using a current and voltage (I-V) tester. The I-V tester may perform I-V characteristic tests on the individual PV panels while inverters of the PV systems are disabled. However, the I-V characteristic tests may be time consuming and are, therefore, only performed periodically due to the PV systems not functioning during the I-V characteristic tests. Likewise, the I-V characteristic tests are not performed over periods of time that correspond to different environmental conditions. In addition, the I-V characteristic test are not performed in real time while the PV systems are functioning. Further, the I-V characteristic tests are unable to monitor the strings of PV panels.

Accordingly, there is a need for an improved system for monitoring the PV systems by monitoring individual PV panels and the strings of PV panels at different environmental conditions in real time while the PV systems are functioning.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristic of the claimed subject matter, nor is it intended to be used as an aid in determining the scope of the claimed subject matter.

Some embodiments of the present disclosure monitor a PV system by monitoring both individual PV panels and strings of PV panels at different environmental conditions in real time while a PV system is functioning (e.g., without disabling an inverter of the PV system). In particular, disclosed embodiments may include an I-V system that monitors the individual PV panels and the strings of PV panels at the different environmental conditions in real time while the PV system is functioning.

The I-V system may include an I-V meter that generates I-V data of a corresponding PV panel at predetermined time intervals during operation of the PV panel. The I-V data may be representative of measured I-V of the PV panel at the predetermined time intervals. In addition, the I-V data may be representative of a measured current, a measured voltage, or both of the power signals generated by a corresponding string of PV panels at the predetermined time intervals. The I-V system may also include a communication device that receives the I-V data from the I-V meter. In addition, the communication device may receive environmental data representative of measured environmental conditions at a site of the PV system at the predetermined time intervals.

The I-V system may further include an I-V module configured to receive the I-V data and the environmental data from the communication device. The I-V module may generate I-V characteristic data for the PV panel based on the I-V data and the environmental data. The I-V characteristic data may be representative of actual operating performance of the PV panel over a predetermined period of time. The predetermined period of time may correspond to a duration of the predetermined time intervals. In addition, the I-V module may monitor the corresponding string of PV panels based on the measured current, the measured voltage, or both of the power signals generated by the strings of PV panels.

Therefore, the I-V system may monitor the PV system at the level of the strings of PV panels and at a more granular level of individual PV panels. In addition, the I-V system may monitor the strings of PV panels and the individual PV panels without disabling the inverter. Likewise, the I-V system may monitor strings of PV panels and the individual PV panels in real time over the predetermined period of time and at different environmental conditions. Further, the I-V system may monitor the strings of PV panels and the individual PV panels of PV systems that do not include a combiner.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example PV system that includes an I-V system configured to monitor individual PV panels and strings of PV panels;

FIG. 2 illustrates a block diagram of one example of the communication device and irradiance meter of FIG. 1;

FIG. 3 illustrates a block diagram of an example I-V meter of the I-V system of FIG. 1;

FIG. 4A illustrates a graphical representation of a simulated example I-V characteristic curve generated using the I-V system of FIG. 1;

FIG. 4B illustrates a graphical representation of the simulated example I-V characteristic curve overlaid with a simulated power characteristic curve captured using the I-V system of FIG. 1;

FIG. 5 illustrates an operational diagram of an example PV system that includes the I-V system configured to monitor individual PV panels and strings of PV panels;

FIGS. 6-10 illustrate screen shots of example graphical user interfaces (GUIs);

FIGS. 11A and 11B illustrate example manufacturing data for a PV panel; and

FIG. 12 illustrates a flowchart of a method; all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

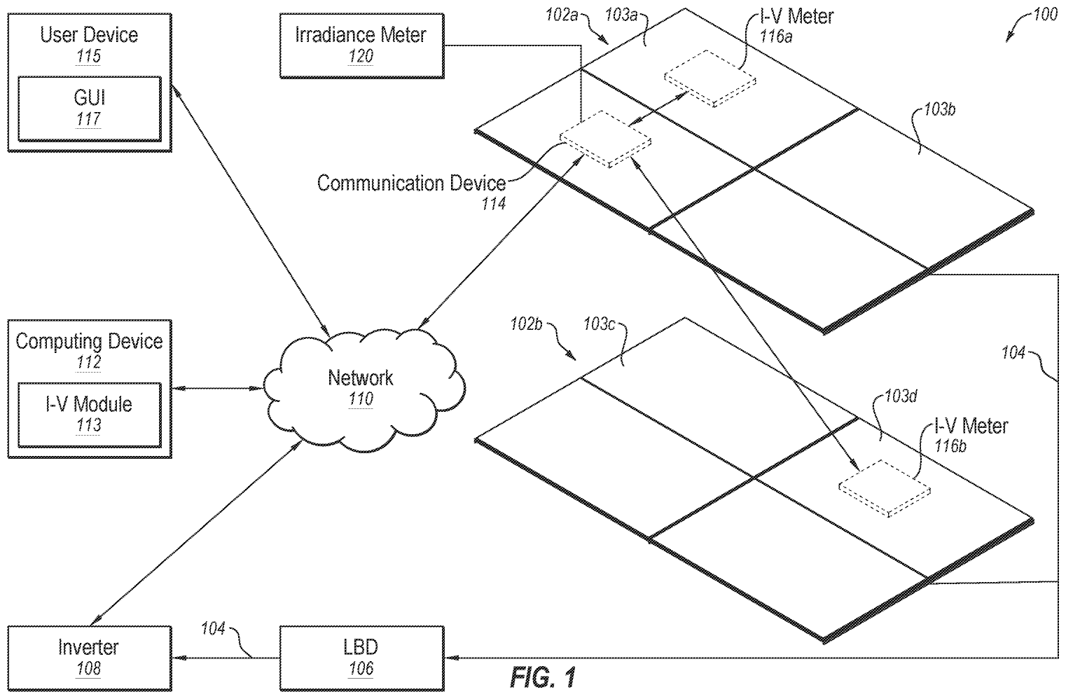

Referring to FIG. 1, a block diagram of an example PV system 100 that includes an I-V system configured to monitor individual PV panels 103a and 103d and strings of PV panels 102a-b is shown. The I-V system may include I-V meters 116a-b, a communication device 114, an I-V module 113, an irradiance meter 120, or some combination thereof. The I-V system may be configured to generate I-V characteristic data to monitor the individual PV panels 103a and 103d and the strings of PV panels 102a-b.

The strings of PV panels 102a-b may generate power signals based on solar radiation collected by the PV panels 103a-d (generally referred to in the present disclosure as PV panels 103). The strings of PV panels 102a-b may provide the power signals to an inverter 108 via a lead assembly 104, which permits the PV system 100 to operate without a combiner. The lead assembly 104 may include the lead assembly described in U.S. Pat. No. 10,992,254 titled “LEAD ASSEMBLY FOR CONNECTING SOLAR PANEL ARRAYS TO INVERTER,” U.S. Pat. No. 11,689,153 titled “LEAD ASSEMBLY FOR CONNECTING SOLAR PANEL ARRAYS TO INVERTER,” and U.S. patent application Ser. No. 18/341,665 titled “LEAD ASSEMBLY FOR CONNECTING SOLAR PANEL ARRAYS TO INVERTER” each of which is incorporated in the present disclosure by reference in its entirety. The PV system 100 may include a load break disconnect (LBD) 106 in line with the lead assembly 104. The LBD 106 may be configured to disconnect to create an open within the lead assembly 104. The inverter 108 may convert the power signals to a signal compatible with a grid or other power systems.

The I-V meters 116a-b may generate I-V data corresponding to the PV panels 103a and 103d and/or the strings of PV panels 102a-b at predetermined time intervals while the inverter 108 is enabled. The I-V data may be representative of measured I-V of the PV panels 103a and 103d at the predetermined time intervals. In addition, the I-V data may be representative of the measured current, the measured voltage, or both of the power signals generated by the strings of PV panels 102a-b at the predetermined time intervals.

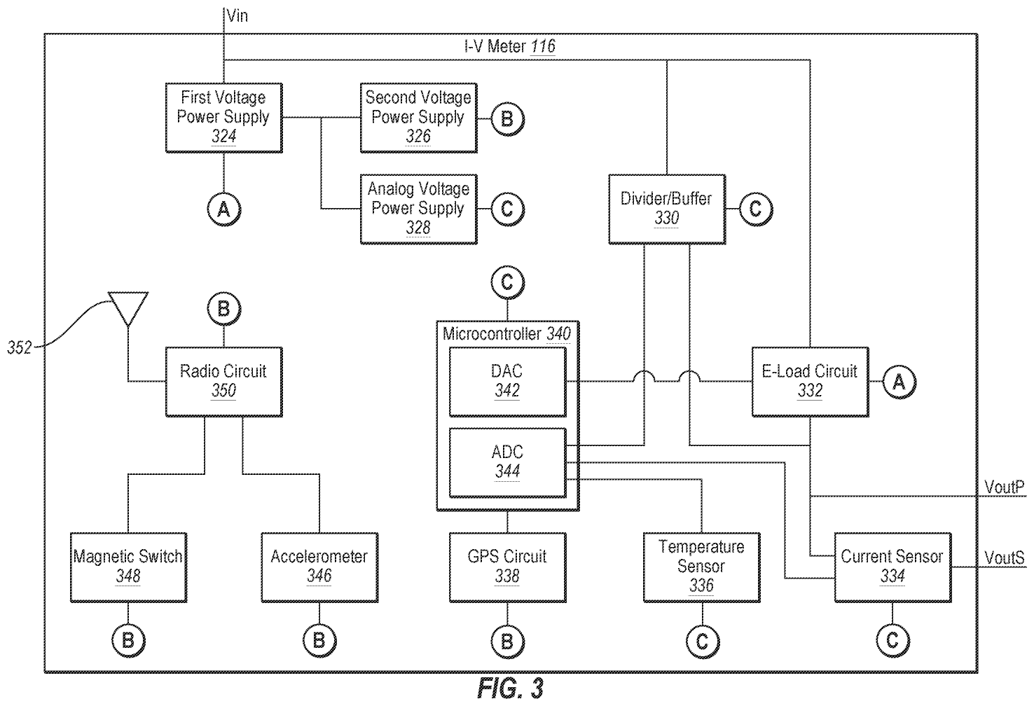

The I-V system may include environmental meters configured to generate environmental data at the predetermined time intervals. The environmental data may be representative of measured environmental conditions at a site of the PV system 100. The environmental meters may include the irradiance meter 120 configured to generate irradiance data representative of a measured irradiance level of the sun at a location of the site of the PV system 100. Additionally or alternatively, the environmental meters may include one or more temperature sensors (such as denoted 336 in FIG. 3) configured to generate temperature data representative of measured temperatures at the PV panels 103a and 103d. Further, the environmental meters may include one or more accelerometers (such as denoted 346 in FIG. 3) configured to generate inclination data representative of measured angles of inclination of the PV panels 103a and 103d at the predetermined time intervals.

The communication device 114 may receive the I-V data from the I-V meters 116a-b. In addition, the communication device 114 may receive the environmental data from the environmental meters. The communication device 114 may transmit the I-V data and the environmental data to a computing device 112 that includes the I-V module 113 via a network 110.

The network 110 may include any communication network configured for communication of signals between any of the communication device 114, a user device 115, the computing device 112, and the inverter 108. The network 110 may include a wired network, a wireless network, or both. The network 110 may include a local area network (LAN), a wide area network (WAN) (e.g., the Internet), and/or other interconnected data paths across which multiple devices may communicate. Additionally or alternatively, the network 110 may include a cellular network that enables communication of data using cellular protocols.

The I-V module 113 may receive the I-V data and the environmental data via the network 110. In addition, the I-V module 113 may generate the I-V characteristic data based on the I-V data and the environmental data. The I-V characteristic data may be representative of actual operating performance of the PV panels 103a and 103d over a predetermined period of time that corresponds to a duration of the predetermined time intervals. Additionally or alternatively, the I-V characteristic data may be representative of actual operating performance of the strings of PV panels 102-v over the pre-determined period of time.

The PV panels 103 may be arranged within the strings of PV panels 102a-b based on corresponding bin classes. For example, the PV panels 103a-b within the string of PV panels 102a may be of a first bin class and the PV panels 103c-d within the string of PV panels 102b may be of a second bin class. The different bin classes may indicate different power ratings of the corresponding PV panels 103. Due to the different bin classes, the individual PV panels 103 may degrade at different rates. For example, the PV panels 103a-b of the first bin class may degrade at a different rate than the PV panels 103c-d of the second bin class.

Each of the I-V meters 116a-b may be coupled to back surfaces of different PV panels 103a and 103d. As shown in FIG. 1, the I-V meter 116a is coupled to the back surface of the PV panel 103a and the I-V meter 116b is coupled to the back surface of the PV panel 103d. In some embodiments, each of the I-V meters 116a-b may be coupled to the PV panels 103 of different bin classes to permit the I-V system to monitor PV panels of different bin classes. For example, the I-V meter 116a may be coupled to the PV panel 103a to permit the I-V system to monitor a PV panel of the first bin class and the I-V meter 116b may be coupled to the PV panel 103d to permit the I-V system to monitor a PV panel of the second bin class. In these and other embodiments, each of the I-V meters 116a-b may be coupled to PV panels 103 of different strings of PV panels 102a-b to permit the I-V system to monitor different PV strings. For example, the I-V meter 116a may be coupled to the PV panel 103a to permit the I-V system to monitor the string of PV panels 102a and the I-V meter 116b may be coupled to the PV panel 103d to permit the I-V system to monitor the string of PV panels 102b.

The I-V meters 116a-b may be electrically coupled in line with power leads of the corresponding PV panel 103a or 103d to permit the current of the corresponding PV panel 103a or 103d to pass through the I-V meters 116a-b. For example, the I-V meter 116a may be coupled in line with the PV panel 103a such that the current of the PV panel 103a passes through the I-V meter 116a and the I-V meter 116b may be coupled in line with the PV panel 103d such that the current of the PV panel 103d passes through the I-V meter 116b.

In the example shown in FIG. 1, the communication device 114 is coupled to the back surface of the PV panel 103a. However, the communication device 114 may be coupled to the back surface of any of the PV panels 103 or may be positioned at a location separate from the PV panels 103, the I-V meters 116a-b, or the irradiance meter 120. The communication device 114 may be configured to be powered by the PV panel 103a.

The communication device 114 may be configured to form a mesh network with the I-V meters 116a-b to wirelessly transmit and receive data. For example, the communication device 114 may form a Wireless Fidelity (Wi-Fi) mesh network with the I-V meters 116a-b. In some embodiments, the Wi-Fi mesh network may include a 2.4 gigahertz (GHz) wireless mesh network. In these and other embodiments, the Wi-Fi mesh network may operate according to a Synapse network application protocol (SNAP) protocol.

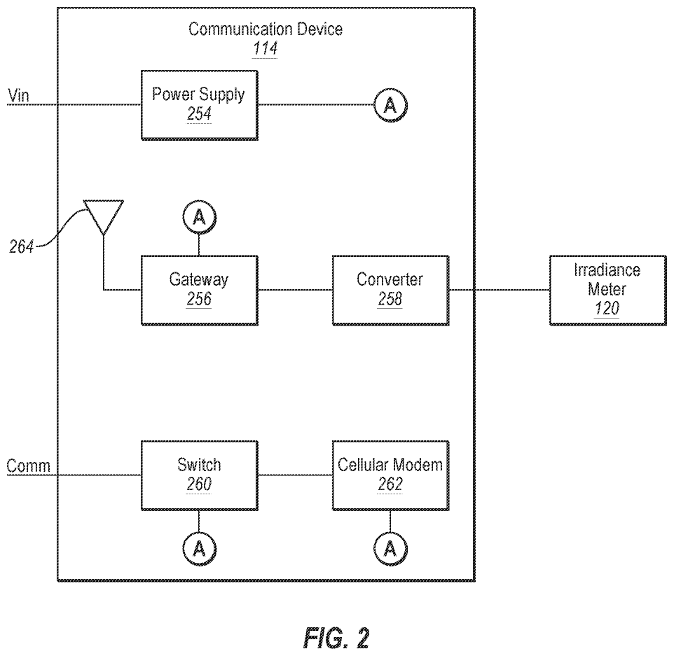

With reference to FIGS. 1 and 2, the communication device 114 may include a gateway 256 (e.g., an embedded computing device) that operates as a hub to collect data from the I-V meters 116a-b and the environmental meters and to transmit the data to the I-V module 113. The gateway 256 may be configured to trigger generation of the I-V data by the I-V meters 116a-b and generation of the environmental data by the environmental meters. The gateway 256 may trigger the I-V meters 116a-b and the environmental meters such that the I-V data and the environmental data are synchronized at corresponding pre-determined time intervals.

The gateway 256 may perform a two-step process to synchronize the I-V data and the environmental data. The first step may include broadcasting a synchronization messages to the I-V meters 116a-b to cause the I-V meters 116a-b to generate the I-V data at the predetermined time intervals and to the environmental meters to generate the environmental data also at the predetermined time intervals. The second step may include broadcasting a polling message to the I-V meters 116a-b and the environmental meters to trigger the I-V meters 116a-b and the environmental meters to transmit the I-V data and the environmental data to the communication device 114.

An example of the communication device 114, the I-V meters 116a-b, and the environmental meters generating the I-V data and the environmental data at first predetermined time interval will now be discussed. The gateway 256 may generate and provide the synchronization message to an antenna 264 of the communication device 114, which wirelessly broadcasts the synchronization message to the I-V meters 116a-b. In addition, the gateway 256 may provide the synchronization message to a converter 258 that converts it to a format that is compatible with the irradiance meter 120. The converter 258 may include a universal serial bus (USB) to recommended standard (RS) 232/RS485/transistor-transistor-logic (TTL) converter. The converter 258 may provide the synchronization message to the irradiance meter 120.

The irradiance meter 120 may be positioned at a location within a site of the PV system 100 separate from the PV panels 103, the I-V meters 116a-b, and the communication device 114. The irradiance meter 120 may measure the irradiance level of the sun at the site of the PV system 100 responsive to receiving the synchronization message. In addition, the irradiance meter 120 may generate irradiance data representative of the measured level of irradiance of the sun at the first predetermined time interval.

With reference to FIG. 3, a block diagram of an example I-V meter 116 is shown, which may correspond to the I-V meters 116a-b of FIG. 1. An antenna 352 of the I-V meter 116 may receive the broadcasted synchronization message and may provide the synchronization message to a radio circuit 350. The radio circuit 350 may convert the synchronization message to a format that is compatible with a microcontroller 340 of the I-V meter 116. The microcontroller 340 may enable an E-load circuit 332, a divider/buffer 330, a current sensor 334, a temperature sensor 336, or an accelerometer 346 responsive to receiving the converted synchronization message.

With reference to FIGS. 1 and 3, the E-load circuit 332 may include a programmable load circuit configured to draw a configurable current load from the corresponding PV panel 103a or 103d during the first predetermined time interval. For example, the E-load circuit 332 may draw a first current load and a second current load during the first predetermined time interval.

The E-load circuit 332 may be electrically coupled to a positive input terminal of the I-V meter 116 (shown as Vin in FIG. 3) and a negative output terminal of the I-V meter 116 (shown as VoutP in FIG. 3). The positive output terminal of the I-V meter 116 may correspond to a positive lead of the corresponding PV panel 103a or 103d. In addition, the negative output terminal of the I-V meter 116 may correspond to a negative lead of the corresponding PV panel 103a or 103d.

The microcontroller 340 may include a digital to analog converter (DAC) 342 that generates a voltage configured to enable the E-load circuit 332. A level of the voltage may set the configurable current load that the E-load circuit 332 draws. For example, a first level of the voltage may set the configurable current load to draw the first current load and a second level of the voltage may set the configurable current load to draw the second current load.

The E-load circuit may include an op-amp buffer configured to control a transistor based on the voltage from the DAC 342. In some embodiments, the transistor may include an N-channel metal-oxide-semiconductor field-effect transistor (MOSFET). The op-amp may receive the voltage from the DAC 342 and apply a gain voltage to the transistor to control a current that passes through the transistor. In addition, the E-load circuit may include a resistor in series with the transistor to provide voltage feedback to regulate the configurable current load.

The E-load circuit 332 may draw the configurable current load to alter an operating point of the corresponding PV panel 103a or 103d to permit other components to measure parameters of the corresponding PV panel 103a or 103d at the altered operating point. For example, the E-load circuit may alter the operating point of the corresponding PV panel 103a or 103d to permit the divider/buffer 330 to measure a voltage of the corresponding PV panel 103a or 103d at the altered operating point. As another example, the E-load circuit 332 may alter the operating point of the corresponding PV panel 103a or 103d to permit the current sensor 334 to measure a current of the configurable current load and the power signals generated by the corresponding string of PV panels 102a or 102b at the altered operating point. In some embodiments, the E-load circuit 332 may not draw the configurable load and the divider/buffer 330 and the current sensor 334 may measure the corresponding voltage and current of the corresponding PV panel 103a or 103d at an unaltered operating point.

The divider/buffer 330 may include a voltage divider configured to measure a voltage between the positive input terminal and the negative output terminal during operation of the corresponding PV panel 103a or 103d at the first predetermined time interval. The divider/buffer 330 may be electrically coupled to the positive input terminal of the I-V meter 116 (shown as Vin in FIG. 3), an analog to digital converter (ADC) 344, and the negative output terminal of the I-V meter 116 (shown as VoutP in FIG. 3).

The divider/buffer 330 may measure the voltage between the positive input terminal and the negative output terminal when the E-load circuit 332 is altering the operating point of the corresponding PV panel 103a or 103d. For example, the divider/buffer 330 may measure the voltage between the positive input terminal and the negative output terminal for the first current load and the second current load. The divider/buffer 330 may provide a voltage to the ADC 344 based on the measured voltage.

The ADC 344 may generate voltage data representative of the measured voltage between the positive input terminal and the negative output terminal. For example, the ADC 344 may generate first voltage data based on the voltage between the positive input terminal and the negative output terminal for the first current load and second voltage data based on the voltage between the positive input terminal and the negative output terminal for the second current load. The microcontroller 340 may store the voltage data.

The temperature sensor 336 may include a thermistor configured to measure a temperature at the corresponding PV panel 103a or 103d at the first predetermined time interval. In some embodiments, the temperature sensor 336 may include a negative temperature coefficient (NTC) thermistor a low-temperature coefficient resistor arranged as a voltage divider.

The temperature sensor 336 may measure the temperature at the corresponding PV panel 103a or 103d at the first predetermined time interval. In addition, the temperature sensor 336 may provide a voltage to the ADC 344 based on the measured temperature. The ADC 344 may generate temperature data representative of the measured temperature at the first predetermined time interval. The microcontroller 340 may store the temperature data.

The current sensor 334 may measure current of a negative output terminal of the I-V meter 116 (shown as VoutS in FIG. 3) at the first predetermined time interval. The current sensor 334 may include a Hall-effect current sensor configured to measure a magnetic field of the negative output terminal of the I-V meter 116 at the first predetermined time interval.

The current sensor 334 may measure the current of the negative output terminal when the E-load circuit 332 is altering the operating point of the corresponding PV panel 103a or 103d. For example, the current sensor 334 may measure the current of the negative output terminal for the first current load and the second current load. The current of the negative output terminal may include the configurable current load and a current of the power signal generated by the corresponding string of PV panels 102a or 102b.

The current sensor 334 may provide a voltage to the ADC 344 based on the measured current. The ADC 344 may generate current data representative of the measured current of the negative output terminal. For example, the ADC 344 may generate first current data based on the current of the negative input terminal for the first current load and second current data based on the current of the negative input terminal for the second current load. The microcontroller 340 may store the current data.

The accelerometer 346 may be configured to measure an angle of inclination of the corresponding PV panel 103a or 103d. The accelerometer 346 may measure the angle of inclination of the corresponding PV panel 103a or 103d at the first predetermined time interval. In addition, the accelerometer 346 may generate inclination data representative of the angle of inclination of the corresponding PV panel 103a or 103d.

Referring back to FIGS. 1 and 2, the gateway 256 may generate a poll message configured to trigger the I-V meters 116a-b and the environmental meters to transmit the I-V data and the environmental data. The gateway 256 may provide the poll message to the antenna 264, which may wirelessly broadcast it to the I-V meters 116a-b. In addition, the gateway 256 may provide the poll message to the converter 258 to convert to a format that is compatible with the irradiance meter 120. The converter 258 may provide the poll message to the irradiance meter 120.

The irradiance meter 120 may provide the irradiance data to the converter 258 in response to the poll message. The converter 258 may convert the irradiance data to a format that is compatible with the gateway 256. For example, the converter 258 may convert the irradiance data to the USB format. The gateway 256 may store the irradiance data.

Referring back to FIGS. 1 and 3, the antenna 352 of the I-V meter 116 may receive the broadcasted poll message and provide it to the radio circuit 350. The radio circuit 350 may convert the poll message to a format that is compatible with the microcontroller 340. The microcontroller 340 may provide the current data, the voltage data, or the temperature data to the radio circuit 350 responsive to the poll message. In addition, the radio circuit 350 may receive the inclination data from the accelerometer 346 responsive to the poll message. The radio circuit 350 may format the current data and the voltage data as the I-V data in a format for transmission by the antenna 352. Likewise, the radio circuit 350 may format the temperature data and the inclination data as the environmental data in a format for transmission by the antenna 352. The antenna 352 may wirelessly transmit the I-V data and the environmental data to the communication device 114.

Referring back to FIGS. 1 and 2, the antenna 264 of the communication device 114 may receive the I-V data and the environmental data transmitted by the I-V meter 116. The gateway 256 may receive the I-V data and the environmental data from the antenna 264. The gateway 256 may also store the I-V data and the environmental data for transmission to the I-V module 113. The gateway 256 may process the I-V data and the environmental data for transmission via the network 110.

In some embodiments, the gateway 256 may prepare the I-V data and the environmental data for transmission via the network 110 configured as a LAN. In these embodiments, the gateway 256 may provide the I-V data and the environmental data to a switch 260, which may route the I-V data and the environmental data to the network 110 via a communication terminal of the communication device 114 (shown as Comm in FIG. 2). In some embodiments, the switch 260 may include an ethernet hub.

In some embodiments, the gateway 256 may prepare the I-V data and the environmental data for transmission via the network 110 configured as a cellular network. In these embodiments, the gateway 256 may provide the I-V data and the environmental data to the switch 260, which may route the I-V data and the environmental data to a cellular modem 262. The cellular modem 262 may format the I-V data and the environmental data for transmission by the cellular modem 262 according to cellular communication protocols. The cellular modem 262 may transmit the I-V data and the environmental data to the I-V module 113 via the network 110.

The I-V system may repeat the two-step process multiple times at different predetermined time intervals to generate the I-V characteristic data based on the I-V data and the environmental data over the predefined period of time corresponding to the duration of the predetermined time intervals. The predefined period of time may correspond to an hour, multiple hours, a day, multiple days, a week, multiple weeks, a month, or longer periods of time.

With reference to FIG. 1, In some embodiments, the inverter 108 may measure a power level of the power signals generated by the strings of PV panels 102a-b that are received by the inverter 108. The inverter 108 may transmit utilization data representative of the measured power level of the power signals to the I-V module 113 via the network 110. The utilization data may represent a total power level of the site, a total power level of the different strings of PV panels 102a-b, or both. The I-V module 113 may cause the utilization to be displayed via a GUI 117 on the user device 115.

The I-V module 113 may include code and routines configured to enable the computing device 112 to perform one or more operations with respect to monitoring the individual PV panels 103a and 103d and the strings of PV panels 102a-b. The I-V module 113 may be implemented using hardware including a processor, a microprocessor (e.g., to perform or control performance of one or more operations), a field-programmable gate array (FPGA), or an application-specific integrated circuit (ASIC). In some embodiments, the I-V module 113 may be implemented using a combination of hardware and software.

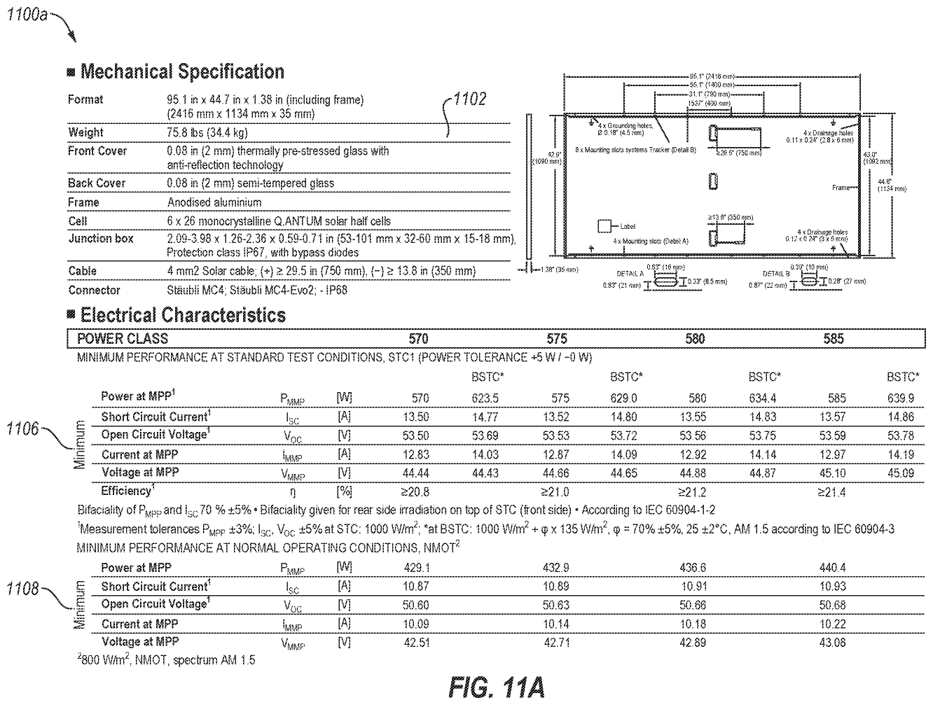

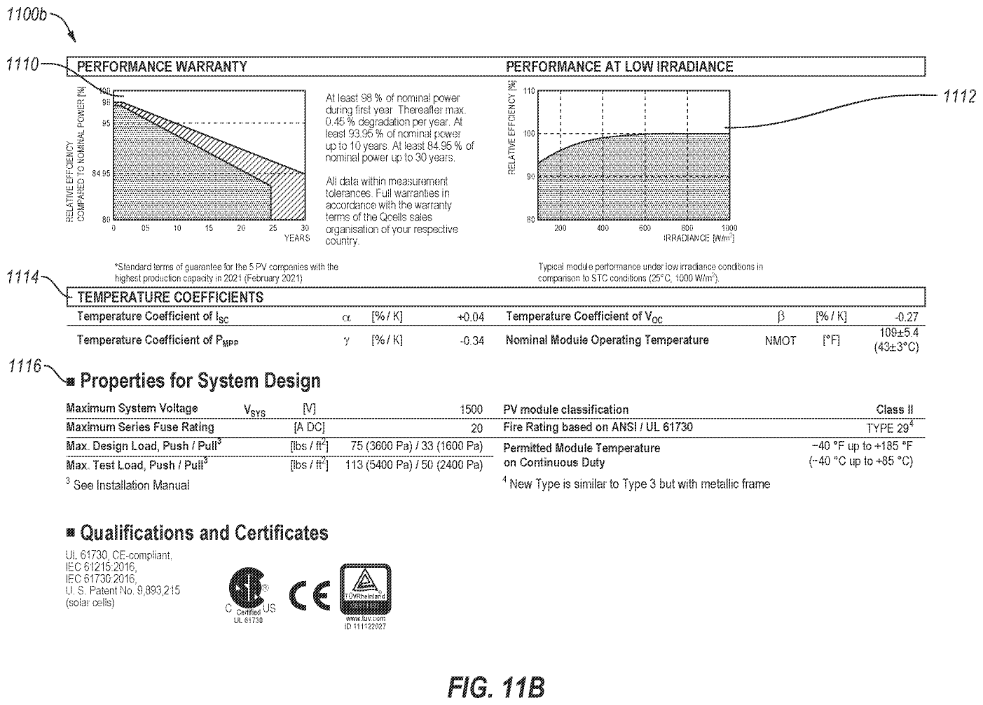

The I-V module 113 may determine a utilization ratio of the PV system 100 based on the utilization data and a total capacity of the PV system 100. The I-V module 113 may compare the power level of the power signals that are received by the inverter 108 to the total capacity of the PV system 100 to determine the utilization ratio. The I-V module 113 may determine the total capacity of the PV system 100 based on manufacturing data corresponding to the PV panels 103. The manufacturing data corresponding to the PV panels 103 may include a brand and/or make, the bin class, a serial number, a thermal coefficient rating, an efficiency rating, or any other appropriate data of the corresponding PV panels 103a or 103b. Example manufacturing data is illustrated and described in more detail below in relation to FIGS. 11A and 11B.

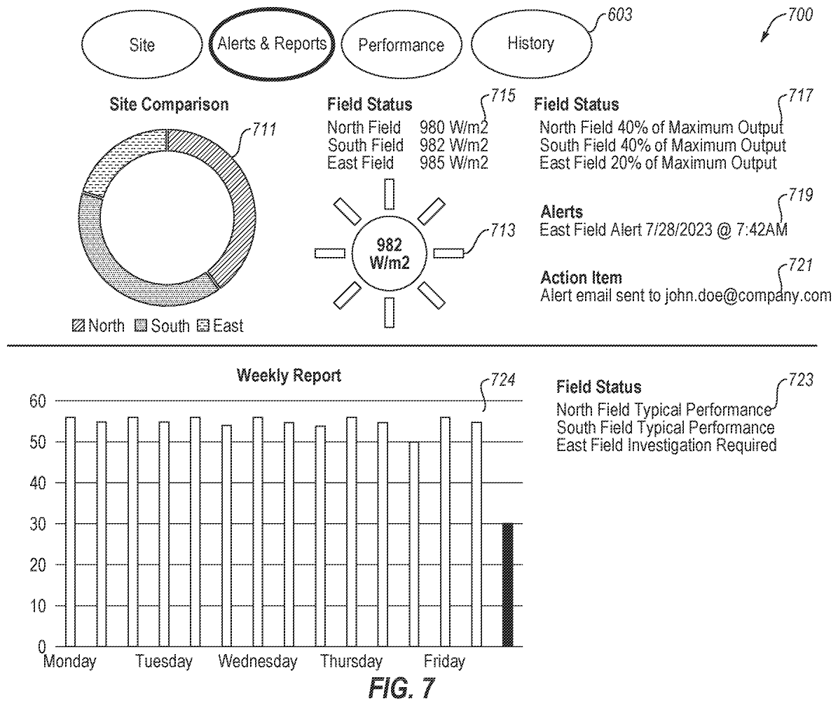

In some embodiments, if the utilization ratio is less than a threshold percentage, the I-V module 113 may identify the PV system 100 for investigation. The I-V module 113 may cause the utilization ratio to be displayed via the GUI 117. A screen shot of an example GUI 700 displaying utilization ratios of multiple PV systems is illustrated and described in more detail below in relation to FIG. 7.

The I-V module 113 may determine an efficiency of the PV panels 103a or 103d based on the I-V data. The I-V module 113 may compare the power level of the corresponding PV panel 103a or 103d to the power level of the corresponding string of PV panels 102a or 102b or to the power level of portions of the PV system 100. The I-V module 113 may determine the power level of the corresponding PV panel 103a or 103d based on the I-V data. In addition, the I-V module 113 may determine the power level of the corresponding string of PV panels 102a or 102 b or the power level of the portions of the PV system 100 based on the I-V data. In some embodiments, if a difference between the amount of power generated by the corresponding PV panel 103a or 103d and the power level of the corresponding string of PV panels 102a or 102b or the power level of the portions of the PV system 100 exceeds a corresponding threshold value, the I-V module 113 may identify the corresponding PV panels 103a or 103d for inspection. The I-V module 113 may cause the efficiency of the PV panels 103a or 103d to be displayed via the GUI 117.

The I-V module 113 may determine a difference between the power signals generated by the different strings of PV panels 102a-b or different portions of the PV system 100 based on the I-V data. The I-V module 113 may determine anomalies within the PV system 100 based on the difference between the power signals generated by the different strings of PV panels 102a-b or different portions of the PV system 100. For example, if the power signal generated by the string of PV panels 102a is much higher than the power signal generated by the string of PV panels 102b, the I-V module 113 may identify the string of PV panels 102b for inspection. In some embodiments, if the difference between the power signals generated by the different strings of PV panels 102a-b or portions of the PV system 100 exceeds a corresponding threshold value, the I-V module 113 may identify one or more of the strings of PV panels 102a-b or the portions of the PV system 100 for investigation. The I-V module 113 may cause the difference between the power signals to be displayed via the GUI 117. A screen shot of an example GUI 700 displaying differences between the power signals generated by multiple PV systems is illustrated and described in more detail below in relation to FIG. 7

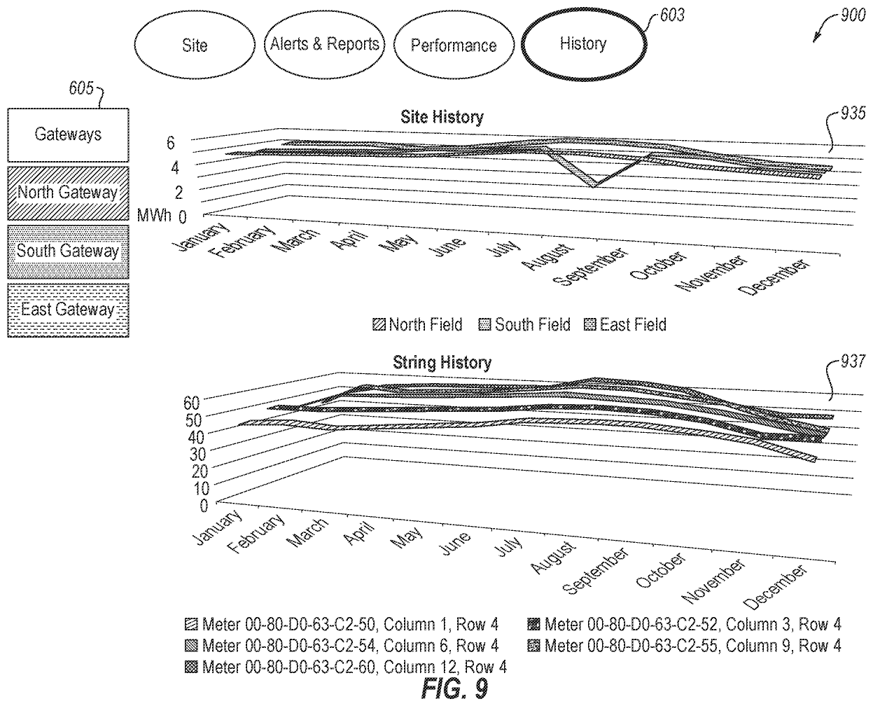

The I-V module 113 may generate a historical report indicating operation of the strings of PV panels 102a-b, the individual PV panels 103a or 103d, or both over a period of time. The I-V module 113 may generate the historical report based on the I-V data, the I-V characteristic data, and/or the environmental data. The historical report may indicate power levels of the power signals generated by the strings of PV panels 102a-b, irradiance levels of the sun, temperatures of the PV panels 103a or 103d, angles of inclination of the PV panels 103a or 103d, or some combination thereof over the period of time. In some embodiments, the period of time for the historical report may correspond to the predefined period of time. In other embodiments, the period of time for the historical report may correspond to part of the pre-defined period of time or multiple predefined periods of time. The I-V module 113 may cause the historical report to be displayed via the GUI 117. A screen shot of an example GUI 900 displaying a historical report is illustrated and described in more detail below in relation to FIG. 9.

The I-V module 113 may identify issues with the strings of PV panels 102a-b or issues with the inverter 108 based on the I-V data, the I-V characteristic data, the environmental data, or the utilization data. The I-V module 113 may perform various calculations using the I-V data, the I-V characteristic data, the environmental data, or the utilization data to identify the issues. In some embodiments, the I-V module 113 may identify one or more of the strings of PV panels 102a-b for investigation based on the identified issues. The I-V module 113 may cause the identified issues to be displayed via the GUI 117. A screen shot of an example GUI 700 displaying issues with a PV system is illustrated and described in more detail below in relation to FIG. 7

The I-V module 113 may generate periodic reports indicating an overview of operation of the PV system 100 for a corresponding period of time. The periodic reports may indicate the utilization of the PV system 100, the efficiency of the PV panels 103a or 103d, the difference between the power signals generated by the different strings of PV panels 102a-b, identified issues with the strings of PV panels 102a-b, or identified issues with the inverter 108 for the corresponding period of time. In some embodiments, the I-V module 113 may generate the periodic reports hourly, daily, weekly, monthly, or other periods of time. The I-V module 113 may cause the periodic reports to be displayed via the GUI 117. A screen shot of an example GUI 700 displaying a periodic report is illustrated and described in more detail below in relation to FIG. 7.

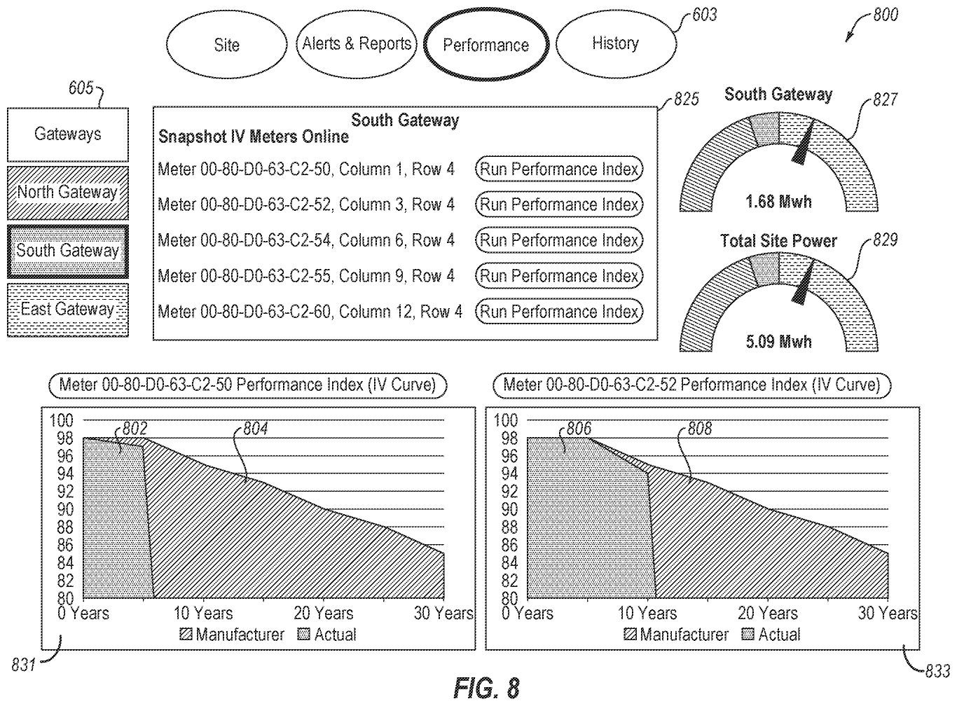

The I-V module 113 may generate an I-V characteristic curve based on the I-V characteristic data. The I-V characteristic curve may indicate performance of the corresponding PV panel 103a or 103d over a corresponding period of time. The I-V characteristic curve may graphically represent changes in current of the corresponding PV panel 103a or 103d as changes in voltage of the corresponding PV panel 103a or 103d occurred. The I-V module 113 may cause the I-V characteristic curve to be displayed via the GUI 117. In some embodiments, the I-V module 113 may compensate for inaccuracies in the measured current due to environmental conditions such as the temperature at the I-V meter 116. A screen shot of an example GUI 800 displaying I-V characteristic curves is illustrated and described in more detail below in relation to FIG. 8.

The I-V module 113 may generate expected I-V characteristic data based on the environmental data and the manufacturing data of the corresponding PV panel 103a or 103d. The expected I-V characteristic data may be representative of expected operating performance of the PV panels 103a or 103d over the predetermined period of time. The I-V module 113 may generate an expected I-V characteristic curve based on the expected I-V characteristic data. The expected I-V characteristic curve may graphically represent expected changes in current of the corresponding PV panel 103a or 103d as changes in voltage of the corresponding PV panel 103a or 103d occur for environmental conditions experienced by the corresponding PV panel 103a or 103d.

In some embodiments, the I-V module 113 may adjust the expected I-V characteristic curve based on the environmental data. For example, the expected I-V characteristic curve may be adjusted based on the irradiance level of the sun, the temperature at the corresponding PV panel 103a or 103d, and/or the angle of inclination of the corresponding PV panel 103a or 103d over the corresponding period of time. In some embodiments the I-V module 113 may determine an angle of incidence of solar radiation with the corresponding PV panel 103a or 103d based on the inclination data. In these and other embodiments, the I-V module 113 may adjust the expected I-V characteristic curve based on the angle of incidence. In addition, the I-V module 113 may determine the temperature at the corresponding PV panel 103a or 103d using the Steinhart-Hart equation along with a known reference voltage of the temperature sensor 336, the voltage provided to the ADC 344, a resistor value of the low-temperature coefficient resistor, and various parameters of the thermistor.

The I-V module 113 may cause the expected I-V characteristic curve to be displayed via the GUI 117. A screen shot of an example GUI 800 displaying expected I-V characteristic curves is illustrated and described in more detail below in relation to FIG. 8.

The I-V module 113 may compare the I-V characteristic data and the expected I-V characteristic data to determine whether the corresponding PV panels 103a and 103d are operating according to manufacturer specifications. The I-V module 113 may determine a difference between the I-V characteristic data and the expected I-V characteristic data. In some embodiments, the I-V module 113 may determine the difference for a point in time during the period of time. In other embodiments, the I-V module 113 may determine the difference for the period of time.

Responsive to the difference between the I-V characteristic data and the expected I-V characteristic data exceeding a threshold value, the I-V module 113 may generate a message indicating such. In some embodiments, the I-V module 113 may transmit the message to the user device 115 to be displayed to a user via the GUI 117. In these and other embodiments, the I-V module 113 may transmit the message to the user device 115 as an email, a notification, a text message, or any other appropriate message.

Additionally or alternatively, the I-V module 113 may compare the characteristic curve and the expected I-V characteristic curve. The I-V module 113 may determine a difference between the I-V characteristic curve and the expected I-V characteristic curve. In some embodiments, the I-V module 113 may determine the difference for a point in time during the period of time. In other embodiments, the I-V module 113 may determine the difference for the period of time. A screen shot of an example GUI 800 displaying comparisons of I-V characteristic curves and expected I-V characteristic curves is illustrated and described in more detail below in relation to FIG. 8.

Responsive to the difference between the I-V characteristic curve and the expected I-V characteristic curve exceeding a threshold value, the I-V module 113 may generate a message indicating such. In some embodiments, the I-V module 113 may transmit the message to the user device 115 to be displayed to the user via the GUI 117. In these and other embodiments, the I-V module 113 may transmit the message to the user device 115 as an email, a notification, a text message, or any other appropriate message.

In some embodiments, the threshold value may be the same for each of the PV panels 103. In other embodiments the threshold value may be different for one or more of the PV panels 103 compared to other PV panels 103.

With reference to FIGS. 1 and 2, in some embodiments, the gateway 256 may receive a remote trigger signal based on instructions provided by the user via the GUI 117. The remote trigger signal may indicate that the two-step process discussed above is to be performed for the predetermined intervals of time. Additionally, or alternatively, the gateway 256 may perform the two-step process at a pre-determined point in time.

With reference to FIG. 3, in some embodiments, the I-V meter 116 may be configured to operate as an I-V tester to perform I-V characteristic tests on the corresponding PV panel 103a or 103d when the inverter 108 is disabled. In some embodiments, the E-load circuit 332 may apply a series of currents across the corresponding PV panel 103a or 103d and the divider/buffer 330 may measure the voltage of the corresponding PV panel 103a or 103d for each current of the series of currents.

In some embodiments, to perform the I-V characteristic tests, the divider/buffer 330 may measure a voltage (e.g., VOC). of the corresponding PV panel 103a or 103d in an open circuit state. The I-V module 113 or the microcontroller 340 may determine a target terminal voltage (e.g., VTERM) that is equal to a percentage of the VOC. In some embodiments, the target terminal voltage may be equal to forty five percent of the VOC. The E-load circuit 332 may increase the current being applied step wise until the target terminal voltage is measured by the divider/buffer 330. The divider/buffer 330 may measure the voltage at each increased step of the current load.

In some embodiments, the divider/buffer 330 may wait an amount of time after the current load was increased before measuring the voltage to permit the voltage to settle. Alternatively, the divider/buffer 330 may measure the voltage as the current is increased to reduce an amount of time to perform the I-V characteristic tests.

In some embodiments, the I-V meter 116 may wait an amount of time between steps to prevent the E-load circuit 332 from overheating. In some embodiments, each step that the current being applied is increased may be equal to twenty milliamps (mA) when the current load is equal to or below five amps. In these and other embodiments, each step that the current being applied is increased may be equal to one hundred mA when the current load is greater than five amps. The I-V module 113 and/or the microcontroller 340 may determine whether the transistor is operating within a safe operating area for each current load. The I-V module 113 may cause the results of the I-V characteristic tests (e.g., complete I-V characteristic curves) to be displayed via the GUI 117.

With reference to FIGS. 1 and 3, in some embodiments, the I-V module 113 may identify a location of the corresponding PV panel 103a or 103d within the site of the PV system 100 based on location data. In some embodiments, the location data may be generated based on a global positioning system (GPS) signal and/or a magnetic field being detected by the I-V meter 116.

The I-V meter 116 may include a GPS circuit 338 that is configured to receive a GPS signal indicating a location of the corresponding PV panel 103a or 103d. The microcontroller 340 may convert the GPS signal into the location data in a format compatible with the radio circuit 350. The radio circuit 350 may format the location data in a format for transmission by the antenna 352.

The I-V meter 116 may include a magnetic switch 348 that may be configured to detect a magnetic field of a magnet when proximate the I-V meter 116. Responsive to detecting the magnetic field, the magnetic switch 348 may trigger the radio circuit 350 to provide the location data to the antenna 352 for wireless transmission to the communication device 114.

With reference to FIG. 2, the antenna 264 of the communication device 114 may receive the location data transmitted by the I-V meter 116. The gateway 256 may receive the location data from the antenna 264. The gateway 256 may store the location data for transmission to the I-V module 113. The gateway 256 may process the location data for transmission via the network 110.

In some embodiments, the gateway 256 may prepare the location data for transmission via the network 110 configured as a LAN. In these embodiments, the gateway 256 may provide the location data to the switch 260, which may route the location data to the network 110 via the communication terminal of the communication device 114 (shown as Comm in FIG. 2).

In some embodiments, the gateway 256 may prepare the location data for transmission via the network 110 configured as a cellular network. In these embodiments, the gateway 256 may provide the location data to the switch 260, which may route the location data to the cellular modem 262. The cellular modem 262 may format the location data for transmission by the cellular modem 262 according to cellular communication protocols. The cellular modem 262 may transmit the location data to the I-V module 113 via the network 110.

The I-V module 113 may receive the location data and may generate or update a map of the site of the PV system 100 based on the location data. For example, the I-V module 113 may cause the map to be displayed via the GUI 117 with the corresponding PV panel 103a or 103d highlighted to notify the user which I-V meter 116a-b detected the magnetic field. In addition, the I-V module 113 may cause coordinates of the corresponding PV panel 103a or 103d to be displayed via the GUI 117.

The communication device 114 may be parasitically powered by the corresponding PV panel 103a or 103d. For example, a voltage power supply 254 may receive an input voltage via the positive input terminal of the communication device 114 (shown as Vin in FIG. 2). The voltage power supply 254 may power the gateway 256, the switch 260, and the cellular modem 262. The gateway 256, the switch 260, and the cellular modem 262 may receive a voltage from the voltage power supply 254 via a bus (shown as A in FIG. 2) within the communication device 114. In some embodiments, the converter 258 may be coupled to the gateway 256 via a USB cable configured to provide power for the converter 258. The communication device 114 may include a capacitor (not show in FIG. 2) configured to power the communication device 114 at least partially when the corresponding PV panel 103a or 103d is not functioning.

Referring to FIG. 3, the I-V meter 116 may be parasitically powered by the corresponding PV panel 103a or 103d. For example, a first voltage power supply 324 may receive an input voltage via the positive input terminal of the I-V meter 116 (shown as Vin in FIG. 3). The first voltage power supply 324 may convert the input voltage to a first voltage to power a second voltage power supply 326, an analog voltage power supply 328, or the E-load circuit 332. The E-load circuit 332 may receive the first voltage via a first bus (shown as A in FIG. 3). In some embodiments, the first voltage may be equal to five volts.

The second voltage power supply 326 may receive the first voltage and convert it to a second voltage to power the radio circuit 350, the magnetic switch 348, the accelerometer 346, or the GPS circuit 338. The radio circuit 350, the magnetic switch 348, the accelerometer 346, or the GPS circuit 338 may receive the second voltage via a second bus (shown as B in FIG. 3). In some embodiments, the second voltage may be equal to 3.3 volts.

The analog voltage power supply 328 may include an analog power storage device configured to store power and provide the power to the divider/buffer 330, the microcontroller 340, the current sensor 334, or the temperature sensor 336 when the first voltage power supply 324 is not operating. In some embodiments, the analog voltage power supply 328 may include a capacitor. The analog voltage power supply 328 may power the divider/buffer 330, the microcontroller 340, the current sensor 334, or the temperature sensor 336 when the first voltage power supply is not operating to permit the I-V meter 116 to continue generating and storing the I-V data and the environmental data. When the first voltage power supply resumes operation, the radio circuit 350 may also resume operation and the stored I-V data and environmental data may be transmitted to the communication device 114.

Referring to FIG. 1, the PV system 100 is illustrated as including a single communication device 114 and two I-V meters 116a-b monitoring two of the four illustrated PV panels 103 and both of the strings of PV panels 102a-b. However, the PV system 100 may include different numbers of communication devices, I-V meters, PV panels, and/or strings of PV panels. For example, the PV system 100 may include hundreds of PV panels and dozens of strings of PV panels. The PV system 100 may include enough I-V meters to monitor five to ten percent of the hundreds of PV panels. In addition, the PV system 100 may include a gateway per every certain number of I-V meters. For example, the PV system 100 may include one communication device per every two hundred fifty I-V meters.

The PV system 100 is illustrated as including a single irradiance meter 120 as an example. However, the PV system 100 may include any appropriate number of irradiance meters. In some embodiments, the PV system 100 may correspond to a field of PV panels and a PV system may include multiple fields of PV panels and the PV system may include an irradiance meter per field of PV panels of the PV system.

The I-V meters 116a-b are shown in FIG. 1 as being coupled to the back surfaces of the PV panels 103a and 103d as an example. The I-V meters 116a-b may be configured to be moved between the PV panels 103. For example, the I-V meter 116a may be moved from the PV panel 103a to the PV panel 103b and the I-V meter 116b may be moved from the PV panel 103d to the PV panel 103c.

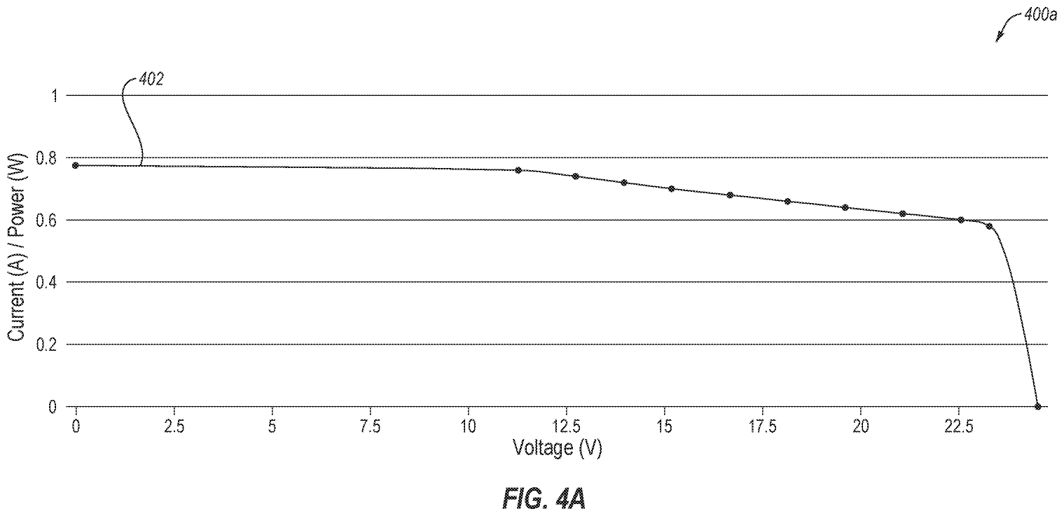

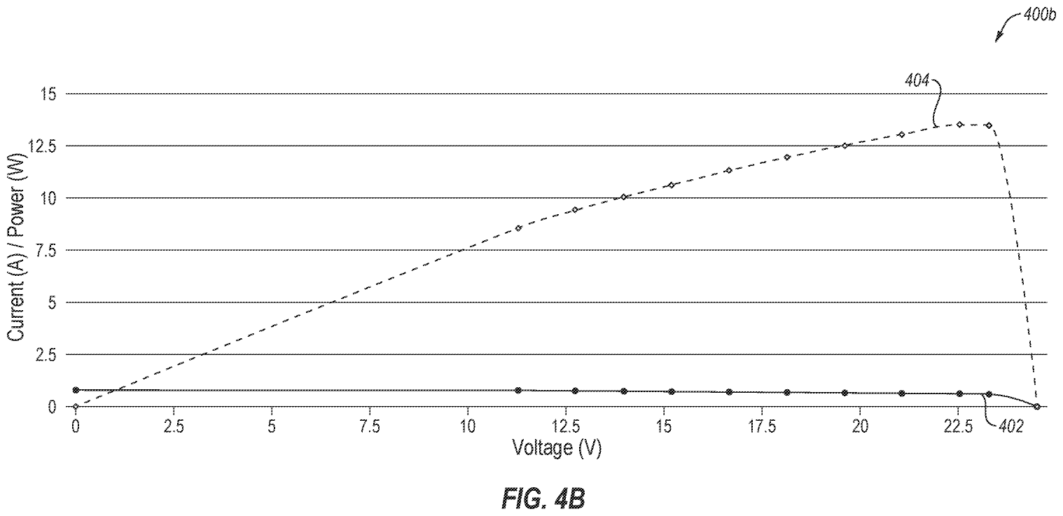

FIG. 4A illustrates a graphical representation 400a of a simulated example I-V characteristic curve 402 captured using the I-V system of FIG. 1. The I-V characteristic curve 402 may indicate performance of a PV panel. The I-V characteristic curve 402 may graphically represent changes in current of the PV panel as changes in voltage occur. As shown in FIG. 4A, as the voltage increases the current remains generally steady until the voltage equals roughly eleven volts at which the current starts to decrease. Further, as shown in FIG. 4A, as the voltage increases from roughly eleven voltage, the current steadily decreases until roughly 23.5 voltage at which the current quickly starts to decrease.

FIG. 4B illustrates a graphical representation 400b of the simulated example I-V characteristic curve 402 overlaid with a simulated power characteristic curve 404 captured using the I-V system of FIG. 1. The power characteristic curve 404 may further indicate performance of the PV panel. The power characteristic curve 404 may graphically represent changes in power of the PV panel as changes in voltage occur. As shown in FIG. 4B, as the voltage increases the power steadily increases until the voltage equals roughly 23.5 volts at which the power quickly starts to decrease.

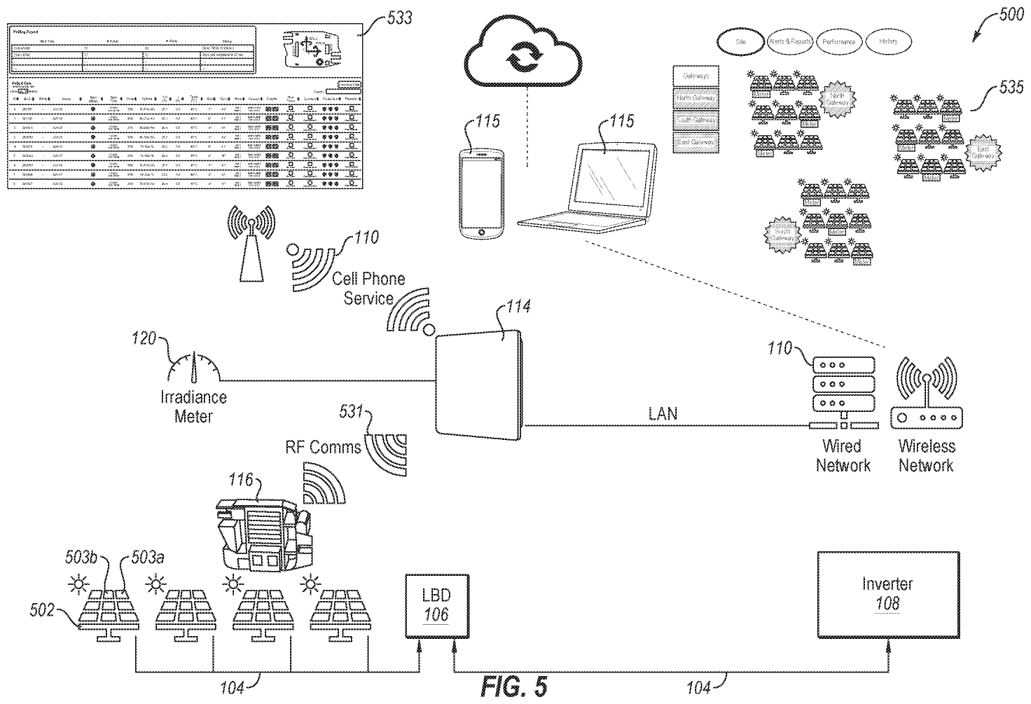

With reference to FIG. 5, an operational diagram of an example PV system 500 that includes the I-V system configured to monitor individual PV panels 503a-b and strings of PV panels 502 is shown. The I-V system may include the I-V meter 116, the communication device 114, and the irradiance meter 120. A single I-V meter 116 is shown in FIG. 5 for case of illustration.

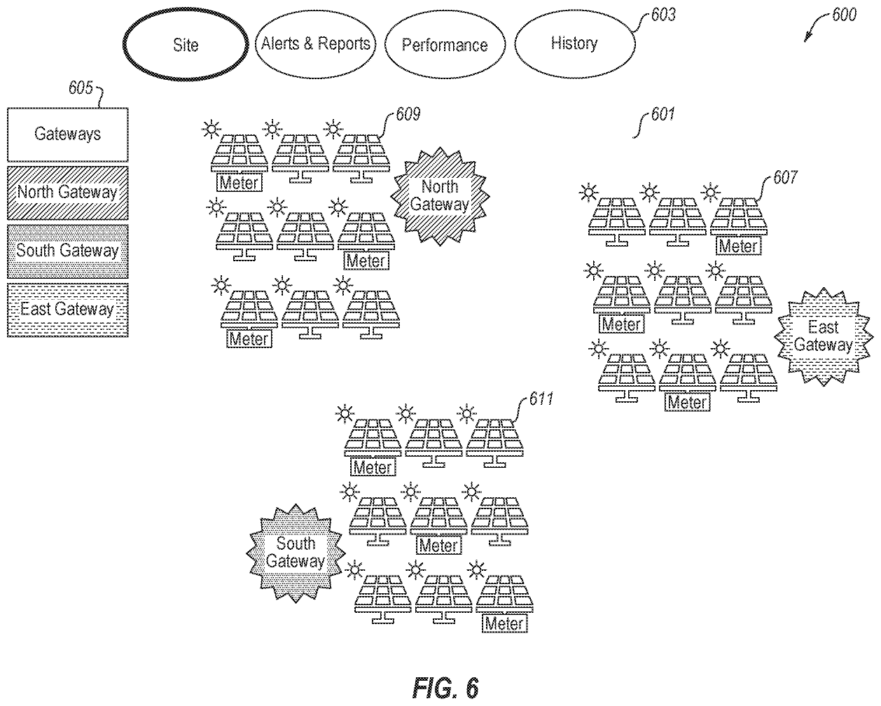

The communication device 114 may form a mesh network 531 with the I-V meter 116. In some embodiments, the mesh network may operate according to radio frequency (RF) standards. As shown in FIG. 5, the network 110 is shown as including a wired network, a wireless network, and a cellular network. In addition, as shown in FIG. 5, the user device 115 is shown as including a smart phone and a laptop. The user device 115 may display a GUI, which may include example GUI 533 (e.g., a utility GUI) and GUI 535 (e.g., a service GUI). Examples of the GUI are discussed in more detail below in relation to FIGS. 6-10.

With reference to FIG. 6, a screen shot of an example GUI 600 is shown. The GUI 600 may correspond to the GUI 117 of FIG. 1 and may be displayed via the user device 115. In addition, the GUI 600 may correspond to the GUI 535 of FIG. 5.

In FIG. 6, the GUI 600 includes a display field 601, a first selection bar 603, and a second selection bar 605. The display field 601, as shown in FIG. 6, displays graphical representations of multiple PV systems 607, 609, and 611 and referred to as “fields.” The graphical representations of the PV systems 607, 609, and 611 may also include graphical representations of I-V meters, labelled “Meter” in FIG. 6, and communication devices, labelled “North Gateway,” “South Gateway,” and “East Gateway” in FIG. 6.

The first selection bar 603, as shown in FIG. 6, includes multiple selection fields that correspond to different types of data that can be displayed. The selection fields of the first selection bar 603, as shown in FIG. 6, includes “Site,” “Alerts & Reports,” “Performance,” and “History.” In FIG. 6, the “Site” selection field is selected, and the GUI 600 includes data corresponding to an entire site of the PV systems 607, 609, and 611.

The second selection bar 605, as shown in FIG. 6, includes multiple selection fields that correspond to different communication devices. The selection fields of the second selection bar 605, as shown in FIG. 6, include “Gateways,” “North Gateway,” “South Gateway,” and “East Gateway” In FIG. 6, the “Gateways” selection field is selected, and the GUI 600 includes data corresponding to all of the I-V meters and all of the communication devices.

With reference to FIG. 7, a screen shot of an example GUI 700 is shown. The GUI 700 may correspond to the GUI 117 of FIG. 1 and may be displayed via the user device 115. In FIG. 7, the GUI 700 includes the first selection bar 603 and the “Alerts & Reports” selection field is selected. The GUI 700 includes data corresponding to any alerts and reports generated by the I-V module 113.

In FIG. 7, the GUI 700 includes a site comparison graph 711, an irradiance value field 713, a field irradiance field 715, a field status field 717, an alerts field 719, an action item field 721, a field status field 723, or a periodic report field 724.

The site comparison graph 711 may indicate percentages of power that are being generated by the different PV systems 607, 609, and 611. As shown in FIG. 7, the site comparison graph 711 includes a circle graph in which the entire circle graphically represents all power being generated and the different colored portions represent percentages of the total power that are being generated by the different PV systems 607, 609, and 611.

The field irradiance field 715 may include current measured irradiance levels for the PV systems 607, 609, and 611. The irradiance value field 713 includes the current measured irradiance level of a selected PV system, which in FIG. 6, is the PV system 611. The field status field 717 may include a list of each of the PV systems 607, 609, and 611 and numerical representations of the corresponding percentage each of the PV systems 607, 609, and 611 are generating. As shown in FIG. 7, the PV system 609 is generating forty percent of the total power, the PV system 611 is generating forty percent of the total power, and the PV system 607 is generating twenty percent of the total power. The listing of the PV system 607 is a different color than the listing of the other PV systems 609 and 611, which indicates that the I-V module 113 has identified the PV system 607 for inspection.

The alerts field 719 lists any alerts that have been generated by the I-V module 113 and, as discussed above, the PV system 607 is operating below the other PV system 609 and 611 and an alert for the PV system 607 has been created and is in the alerts field 719. The action item field 721 lists action items that occur due to the alerts. As shown in FIG. 7, an email was sent to an email address due to the alerts.

The field status field 723 may include a status message for the PV systems 607, 609, and 611. As shown in FIG. 7, the status for the PV systems 609 and 611 are listed as “Typical Performance” and the status for the PV system 607 is listed as “Investigation Required.” The periodic report field 724 as shown in FIG. 7 includes a “Weekly Report” of the PV systems 607, 609, and 611. The weekly report may include an average amount of power generated by the PV systems 607, 609, and 611 for each day of the week.

With reference to FIG. 8, a screen shot of an example GUI 800 is shown. The GUI 800 may correspond to the GUI 117 of FIG. 1 and may be displayed via the user device 115. In FIG. 8, the GUI 800 includes the first selection bar 603 and the second selection bar 605. In FIG. 8, the “Performance” selection field is selected, and the “South Gateway” selection field is selected. The GUI 800 includes an I-V meter connection status field 825, a PV system power graph 827, or a total site power graph 829.

The I-V meter connection status field 825 includes a list of different I-V meters and corresponding columns and rows within the PV system 611. The PV system power graph 827, as shown in FIG. 8, includes different colored sections graphically representing different operating conditions (e.g., good, acceptable, and poor operating conditions) of the corresponding PV system 611. In addition, the PV system power graph 827 may include a numerical representation of the current power being generated and an arrow overlaid the semi-circle graph indicating where the current power falls within the operating conditions.

The total site power graph 829, as shown in FIG. 8, includes different colored sections graphically representing different operating conditions (e.g., good, acceptable, and poor operating conditions) of the site. In addition, the total site power graph 829 may include a numerical representation of the current power being generated and an arrow overlaid the semi-circle graph indicating where the current power falls within the operation ranges.

The GUI 800 may include comparison curve fields 831 and 833. Each of the comparison curve fields 831 and 833 corresponds to a different I-V meter and different PV panels within the PV system 611. The comparison curve fields 831 and 833 include I-V characteristic curves 802 and 806 and expected I-V characteristic curves 804 and 808. The I-V characteristic curves 802 and 806 and the expected I-V characteristic curves 804 and 808 may be generated by the I-V module 113 as discussed above. The I-V characteristic curves 802 and 806 are overlaid the expected I-V characteristic curves 804 and 808 to easily determine whether the corresponding PV panels are operating as expected.

With reference to FIG. 9, a screen shot of an example GUI 900 is shown. The GUI 900 may correspond to the GUI 117 of FIG. 1 and may be displayed via the user device 115. In FIG. 9, the GUI 900 includes the first selection bar 603 and the second selection bar 605. In FIG. 9, the “History” selection field is selected, and the “Gateways” selection field is selected. The GUI 900 includes a site history graph 935 and a string history graph 937. The site history graph 935 may include a ribbon graph in which the different ribbons represent power generated over a year by the different PV systems 607, 609, and 611. As shown in FIG. 9, the PV systems 607, 609, and 611 generally operated the same over the year except that the PV system 611 operated poorly in August.

The string history graph 937 may include a ribbon graph in which the different ribbons represent power generated over a year by different strings of PV panels. As shown in FIG. 7, the strings of PV panels generally operated in unison over the year.

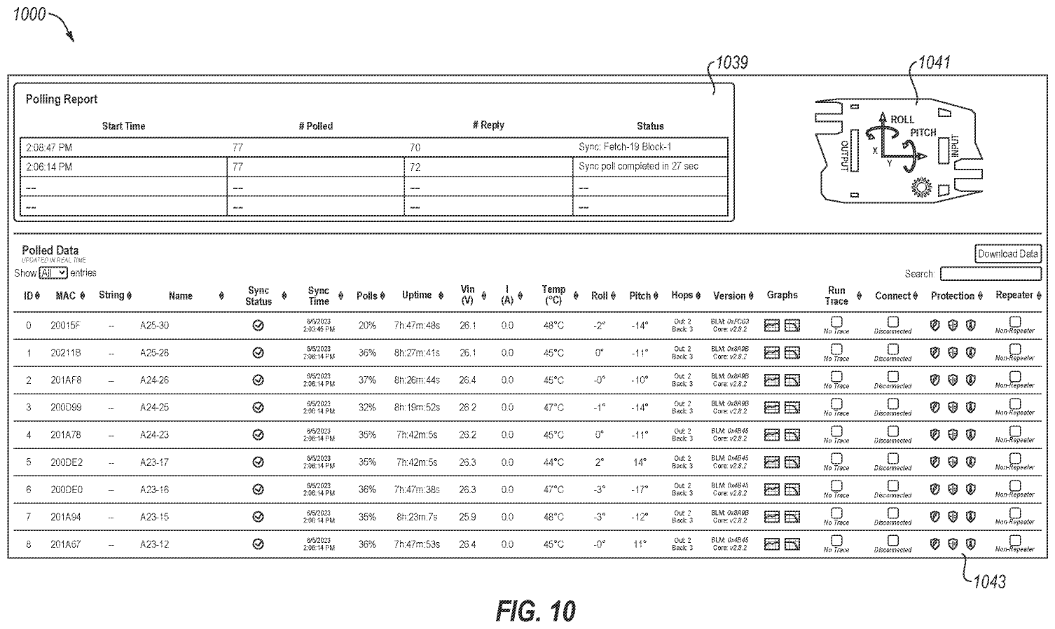

With reference to FIG. 10, a screen shot of an example GUI 1000 is shown. The GUI 1000 may correspond to the GUI 117 of FIG. 1 and may be displayed via the user device 115. In addition, the GUI 1000 may correspond to the GUI 533 of FIG. 5.

The GUI 1000 may include a polling report table 1039, an orientation image 1041, and a polled data table 1043. The polling report table 1039 may list data corresponding to different polling processes performed by communication devices. As shown in FIG. 10, the polling report table 1039 includes a list of start times of the polls, a number of I-V meters polled, a number of I-V meters that provided the corresponding I-V data, or a status of the polls. The orientation image 1041 includes an image of an example I-V meter or a guide indicating which axes correspond to roll and pitch of the I-V meters.

The polled data table 1043 may list data corresponding to different I-V meters. As shown in FIG. 10, the polled data table 1043 includes a list of identification numbers, MAC addresses, names, sync statuses, sync times, poll response statuses, uptimes, or software versions of the different I-V meters. In addition, as shown in FIG. 10, the polled data table 1043 includes a list of voltages, currents, temperatures, roll, or pitch measured by the different I-V meters. Further, as shown in FIG. 10, the polled data table 1043 includes a list of hops to the different I-V meters, graphs corresponding to the different I-V meters, or protection statuses of the different I-V meters. As shown in FIG. 10, the polled data table 1043 includes selection fields to run a trace corresponding to the different I-V meters, to connect to the different I-V meters, and to setup the different I-V meters as repeaters.

FIGS. 11A and 11B illustrate example manufacturing data 1100a and 1100b for a PV panel. As shown in FIG. 11A the manufacturing data 1100a may include a mechanical specification field 1102 that lists various specifications of the PV panel. As shown in FIG. 11A, the manufacturing data 1100a may list possible power classes (e.g., possible bin classes) for the PV panel. Further, as shown in FIG. 11A, the manufacturing data 1100a may list tested operation parameters 1106 and 1108 of the PV panel under different test conditions. The tested operation parameters 1106 may correspond to tested operation of the PV panel under standard test conditions. The tested operation parameters 1108 may correspond to tested operation of the PV panel under normal operating conditions.

As shown in FIG. 11B, the manufacturing data 1100b may include a performance warranty graph 1110, a performance at low irradiance graph 1112, a temperature coefficients field 1114, or properties for system design field 1116. The performance warranty graph 1110 may graphically show relative efficiency of the PV panel compared to nominal power over a period of time. The performance at low irradiance graph 1112 may graphically show relative efficiency of the PV panel at low irradiance levels. The temperature coefficients field 1114 lists temperature coefficients of the PV panels at currents, powers, voltages, and temperatures. The properties for system design field 1116 lists a maximum voltage rating, a maximum fuse rating, a max design load rating, a max test load rating, or other environmental considerations of the PV panel.

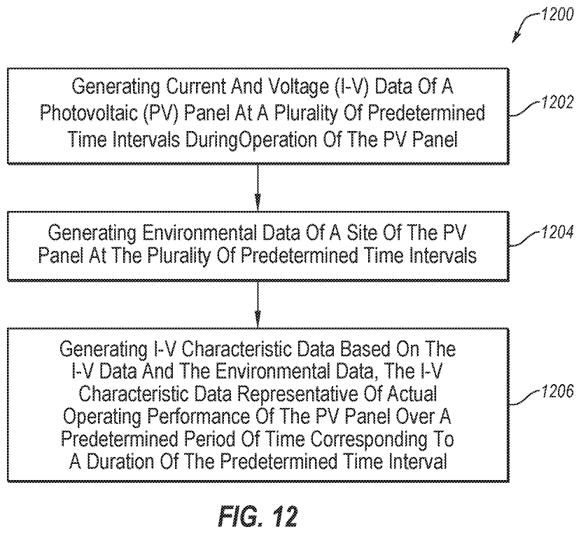

FIG. 12 illustrates a flowchart of an example method 1200 for generating I-V characteristic data. The method 1200 may include one or more blocks 1202, 1204, or 1206. Although illustrated with discrete blocks, the steps and operations associated with one or more of the blocks of the method 1200 may be divided into additional blocks, combined into fewer blocks, or eliminated, depending on the particular implementation.

At block 1202, I-V data of a PV panel may be generated at a plurality of predetermined time intervals during operation of the PV panel. For example, the I-V meters 116a-b of FIG. 1 may generate the I-V data of the PV panels 103a or 103d at the predetermined time intervals. At block 1204, environmental data of a site of the PV panel may be generated at the plurality of predetermined time intervals. For example, the irradiance meter 120 and/or the I-V meters 116a-b of FIG. 1 may generate the environmental data at the predetermined time intervals. At block 1206, I-V characteristic data may be generated. The I-V characteristic data may be generated based on the I-V data and the environmental data. The I-V characteristic data may be representative of actual operating performance of the PV panel over a predetermined period of time corresponding to a duration of the predetermined time intervals. For example, the I-V module 113 may generate the I-V characteristic data based on the I-V data and the environmental data.

What is claimed is:

1. A method comprising:
generating current and voltage (I-V) data of a photovoltaic (PV) panel at a plurality of predetermined time intervals during operation of the PV panel;
generating environmental data of a site of the PV panel at the plurality of predetermined time intervals; and
generating I-V characteristic data based on the I-V data and the environmental data, the I-V characteristic data representative of actual operating performance of the PV panel over a predetermined period of time corresponding to a duration of the predetermined time intervals.

2. The method of claim 1 wherein the environmental data comprises at least one of:
irradiance data representative of a measured level of irradiance of the sun at a location at the site of the PV panel; or
temperature date representative of a measured temperature at the PV panel.

3. The method of claim 1, wherein the generating the I-V data of the PV panel at the plurality of predetermined time intervals comprises at each predetermined time interval:
drawing a first current load from the PV panel;
measuring a voltage of the PV panel for the first current load;
generating first voltage data based on the voltage of the PV panel for the first current load;
measuring a current of the first current load and a power signal generated by a string of PV panels comprising the PV panel;
generating first current data based on the measured current of the first current load and the power signal;
drawing a second current load from the PV panel;
measuring a voltage of the PV panel for the second current load;
generating second voltage data based on the measured voltage of the PV panel for the second current load; and
generating second current data based on the measured current of the second current load and the power signal, wherein the I-V data comprises the first voltage data, the first current data, the second voltage data, and the second current data.

4. The method of claim 1 further comprising
generating expected I-V characteristic data based on the environmental data and manufacturing data, the expected I-V characteristic data representative of expected operating performance of the PV panel over the predetermined period of time;
determining a difference between the I-V characteristic data and the expected I-V characteristic data; and
responsive to the difference between the I-V characteristic data and the expected I-V characteristic data exceeding a threshold value, generating a message indicating that the difference between the I-V characteristic data and the expected I-V characteristic data exceeded the threshold value.

5. The method of claim 4, wherein the PV panel comprises a first PV panel and the threshold value comprises a first threshold value, the method further comprising:
generating additional I-V data of a second PV panel at the plurality of predetermined time intervals during operation of the second PV panel;
generating additional I-V characteristic data based on the additional I-V data and the environmental data, the additional I-V characteristic data representative of actual operating performance of the second PV panel over the predetermined period of time;
generating additional expected I-V characteristic data based on the environmental data and manufacturing data of the second PV panel, the additional expected I-V characteristic data representative of expected operating performance of the second PV panel over the predetermined period of time;
determining a difference between the additional I-V characteristic data and the additional expected I-V characteristic data; and
responsive to the difference between the additional I-V characteristic data and the additional expected I-V characteristic data exceeding a second threshold value, generating a message indicating that the difference between the additional I-V characteristic data and the additional expected I-V characteristic data exceeded the second threshold value.

6. The method of claim 1 further comprising at least one of:
identifying a location of the PV panel within the site of the PV panel based on a location data generated responsive to a magnetic field; or
identifying the location of the PV panel within the site of the PV panel based on a global positioning system (GPS) signal.

7. The method of claim 1 further comprising:
determining an angle of inclination of the PV panel; and
determining an angle of incidence of the PV panel based on the angle of inclination, wherein the I-V characteristic data is further based on the angle of incidence.

8. The method of claim 1 further comprising:
generating an I-V characteristic curve based on the I-V characteristic data; and
displaying the I-V characteristic curve via a graphical user interface.

9. A system comprising:
a current and voltage (I-V) meter configured to generate current and voltage (I-V) data of a photovoltaic (PV) panel at a plurality of predetermined time intervals during operation of the PV panel;
an environmental meter configured to generate environmental data of a site of the PV panel at the plurality of predetermined time intervals;
a communication device configured to:
receive the I-V data from the I-V meter and the environmental data from the environmental meter; and
transmit the I-V data and the environmental data; and
an I-V module configured to:
receive the I-V data and the environmental data from the communication device; and
generate I-V characteristic data based on the I-V data and the environmental data, the I-V characteristic data representative of actual operating performance of the PV panel over a predetermined period of time corresponding to a duration of the predetermined time intervals.

10. The system of claim 9 wherein the environmental meter comprises at least one of:
an irradiance meter configured to generate irradiance data representative of a measured level of irradiance of the sun at a location at the site of the PV panel; or
a temperature sensor configured to measure a temperature at the PV panel.

11. The system of claim 9, wherein the I-V meter, at each predetermined time interval, is configured to:
draw a first current load from the PV panel;
measure a voltage of the PV panel for the first current load;
generate first voltage data based on the voltage of the PV panel for the first current load;
measure a current of the first current load and a power signal generated by a string of PV panels comprising the PV panel;
generate first current data based on the measured current of the first current load and the power signal;
draw a second current load from the PV panel;
measure a voltage of the PV panel for the second current load;
generate second voltage data based on the measured voltage of the PV panel for the second current load; and
generate second current data based on the measured current of the second current load and the power signal, wherein the I-V data comprises the first voltage data, the first current data, the second voltage data, and the second current data.

12. The system of claim 9, wherein the I-V module is configured to:
generate expected I-V characteristic data based on the environmental data and manufacturing data, the expected I-V characteristic data representative of expected operating performance of the PV panel over the predetermined period of time;
determine a difference between the I-V characteristic data and the expected I-V characteristic data; and
responsive to the difference between the I-V characteristic data and the expected I-V characteristic data exceeding a threshold value, generate a message indicating that the difference between the I-V characteristic data and the expected I-V characteristic data exceeded the threshold value.

13. The system of claim 12, wherein:
the PV panel comprises a first PV panel, the threshold value comprises a first threshold value, and the I-V meter comprises a first I-V meter;
the system further comprises a second I-V meter configured to generate additional I-V data of a second PV panel at the plurality of predetermined time intervals during operation of the second PV panel;
the communication device is configured to:
receive the additional I-V data; and
transmit the additional I-V data;
the I-V module is configured to:
receive the additional I-V data;
generate additional I-V characteristic data based on the additional I-V data and the environmental data, the additional I-V characteristic data representative of actual operating performance of the second PV panel over the predetermined period of time;
generate additional expected I-V characteristic data based on the environmental data and manufacturing data of the second PV panel, the additional expected I-V characteristic data representative of expected operating performance of the second PV panel over the predetermined period of time;
determine a difference between the additional I-V characteristic data and the additional expected I-V characteristic data; and
responsive to the difference between the additional I-V characteristic and the additional expected I-V characteristic data exceeding a second threshold value, generate a message indicating that the difference between the additional I-V characteristic data and the additional expected I-V characteristic data exceeded the second threshold value.

14. The system of claim 13, wherein the first threshold value and the second threshold value are the same.

15. The system of claim 9, wherein the I-V meter is configured to generate the I-V data when the PV panel is electrically coupled to an inverter.

16. The system of claim 9, wherein the I-V meter comprises at least one of:
a magnetic switch configured to trigger location data indicating a location of the PV panel within the site of the PV panel responsive to a magnetic field; or
a global positioning system (GPS) circuit configured to generate the location data based on a GPS signal.

17. The system of claim 9, wherein:
the I-V meter comprises an accelerometer configured to generate inclination data representative of an angle of inclination of the PV panel;
the communication device is configured to:
receive the inclination data from the I-V meter; and
transmit the inclination data; and
the I-V module is configured to:
determine an angle of incidence of the PV panel based on the angle of inclination; and
generate the I-V characteristic data further based on the angle of incidence.

18. The system of claim 9, wherein the I-V meter is configured to be powered by I-V of the PV panel and is coupled to a back surface of the PV panel.

19. The system of claim 18, wherein the communication device is coupled to the back surface of the PV panel.

20. The system of claim 18, wherein the communication device is coupled to a back surface of a different PV panel.
